(19) United States
(12) Patent Application Publication
(10) Pub. No.: US 2020/0068169 A1
(43) Pub. Date: Feb. 27, 2020

(54) Methods and Subsystems for Utilizing Home Safety Sensors within a Telepresence Platform

(71) Applicant: Richard Dean Nehrboss, Bumpass, VA (US)

(72) Inventor: Richard Dean Nehrboss, Bumpass, VA (US)

(21) Appl. No.: 16/107,107

(22) Filed: Aug. 21, 2018

(51) Int. Cl. H04N 7/14; H04L 12/28

(52) U.S. Cl. CPC H04N 7/142; H04L 12/2827; H04N 7/148; H04N 7/147

(57) ABSTRACT

The invention relates to a telepresence system including improved methods, systems and techniques for providing remote interaction, monitoring, and transmission of home safety sensors. Said system uses a Telepresence Unit (TU) and any number or variety of home-based sensors comprising the simultaneous or independent display or transmission, on the local interface and on the remote interface, of any or all of the home-state data generated by home-based sensors. Data is collected for the purpose of transmission to non-proximally located human or programmatic operators of aforementioned Telepresence Unit.

### FIELD OF INVENTION

Home safety sensors are used in measuring pertinent ambient conditions within a set premises. For example, a carbon monoxide sensor is typically used to detect localized ambient levels of carbon monoxide of carbon monoxide generated within a house. A door opening detector monitors for the event of a door opening with the relevant party being notified.

Telepresence systems are designed to provide two way conversations between an operator and a user remotely. It has been used in numerous fields including healthcare, maintenance, security, etc. Its application reduces cost and resource consumption for the provision of specialized services. It has not hitherto been used in conjunction with home safety sensors to provide a third party real time home safety data.

### SUMMARY OF THE INVENTION

The invention allows for easy access to home safety data for non-local third parties through the use of a telepresence platform. Applications exist where the use of a telepresence system happens contemporaneously with the local use of numerous home safety sensors. This invention allows for the delegation of the monitoring of these sensors to the operator of said telepresence platform. Such delegation is particularly indicated when the occupants of the monitored home are infirm in some way. This includes those with disability, minority, or old age. This invention describes the monitoring as being achieved through the direct connection of these home safety sensors to the telepresence platform. Operators, either programmatic or manual, are transmitted the home safety data during the operation of the telepresence platform or while the telepresence platform is offline in sleep mode.

Sensors can be linked to the telepresence platform through a number of ways. This includes direct wired connection and wireless connection. The majority of applications are expected to be wireless and one such recommendation follows the use of a 2.45 Ghz band commonly known as Bluetooth. Sensors can include any number of home based sensors which operate in accordance with their design parameters.

### DESCRIPTION OF FIGURES

FIG. 1 shows the internal components and modules of the telepresence unit alone.

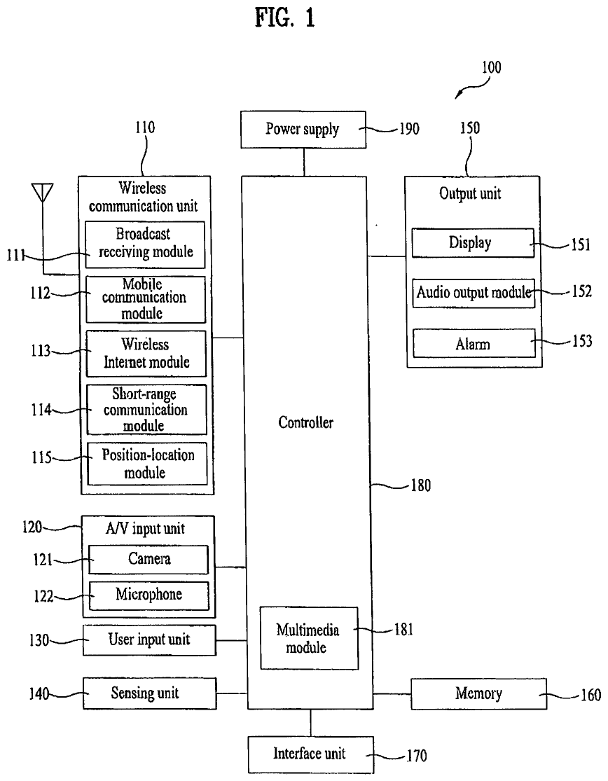

FIG. 2 shows the telepresence unit fulfilling the embodiment of this invention as the hub of numerous home-based sensors along with its link to an offsite operator.

### DETAILED DESCRIPTION

Throughout the course of this description, it should be understood that, while there are innovations within the design of the telepresence unit, the primary goal of this innovation is to interface to any number of home-based sensors for the purpose of generating home-safety information. It is also to be generally understood that the foregoing functionalities can be applicable to various different types and applications of telepresence systems wherein their general use mirrors that of a home. Where “home-based sensors” are referenced in this description, it is understood that this represents merely a class of products and does not constrain their use as it pertains to this invention, nor narrow the scope of the application or enforcement of this patent. Examples of such expanded uses include hospitals, nursing homes, communal living facilities, and shopping malls.

For the remained of this description, “telepresence unit” can be taken to indicate the unit which enables the two-way communication between user and operator or the operator control 260. “Telepresence platform” indicates the entirety of the invention including the interfaced home-based sensors 224. The telepresence unit described in this invention is not constrained by one type of design. While the majority of applications of this invention indicate a mobile unit 230 wherein the operator can drive said unit, the scope of this invention is not limited in this regard and can include stationary telepresence units.

The telepresence unit itself, in accordance to the preferred form of the complete invention can include a number of different components. Each component acts both in the facilitation of the telepresence unit's purpose to allow for two way calls as well as with the integration with any number of home based sensors. The components will be described as follows and include a wireless communication unit 110, an audio/video input unit 120, a sensing unit 140, an output unit 150, a memory unit 160, a controller 180, a power supply unit 190, and and any other component not listed here but necessary for the application of this invention to any specific use case. It is also to be understood that implementing all of the components is not a requirement as greater or fewer components may be implemented. As stated before, each component can contribute either to the independent operation of the telepresence unit, to its inherent function as the hub of home-based sensors 230, or to both.

The wireless communication unit typically includes one or more components which permits wireless communication between the telepresence unit and a wireless communication system or network within which the telepresence unit is located or with any of a number of home-based sensors 224. For instance, the wireless communication unit can include a broadcast receiving module, a mobile communication module 112, a wireless internet module 113 and the like. The broadcast receiving module 111 receives a broadcast signal and/or broadcast associated information from an external broadcast managing server via a broadcast channel. The broadcast channel may include a satellite channel and a terrestrial channel. The broadcast managing server generally refers to a server which generates and transmits a broadcast signal and/or broadcast associated information or a server which is provided with a previously generated broadcast signal and/or broadcast associated information and then transmits the provided signal or information to a terminal. The broadcast associated information includes information associated with a broadcast channel, a broadcast program, a broadcast service provider, etc. The broadcast associated information can be provided via a mobile communication network. In this case, the broadcast associated information can be received by the telepresence unit. The broadcast associated information can be implemented in various forms. For instance, broadcast associated information may include directives to change parameters to various sensors. The broadcast receiving module may be configured to receive broadcast signals transmitted from various types of broadcast systems, this includes broadcasts from the operator of the telepresence unit. Through this method, an operator can change parameters to any subset of home-based sensors. The broadcast signal and/or broadcast associated information received by the broadcast receiving module may be stored in a suitable device, such as a memory. The mobile communication module 112 transmits/receives wireless signals to/from one or more network entities (e.g., base station of the operator, home-based sensors, server, etc.). Such wireless signals may represent audio, video, and data according to text/multimedia message transceivers, among others. The wireless internet module 113 supports Internet access for the telepresence unit. This module may be internally or externally coupled to the telepresence unit. In this case, the wireless Internet technology can include Wireless LAN, Wi-Fi, Wibro, Wimax, HSDPA.

In addition, the wireless communication unit 110 is expected to interface with any number of home-based sensors 224. However, said wireless communication is not a precondition for the scope of this invention. Such communication could conceivably be achieved with any subset of the home-based sensors included in the overall telepresence platform through direct wired communication. This could further be implemented in the form of add-ons which are either permanently or transiently affixed to the telepresence unit. Such sensors could thus be joined with the telepresence unit allowing it to measure ambient readings at different locations within its environment during the course of its operation. Wireless communication with home-based sensors from the telepresence unit could be achieved through LAN, Wi-Fi, Wibro, Wimax, HSDPA in the same way as the aforementioned communication unit. In addition, the preferred method would be any of a number of short range communication standards. This includes standard IEEE 802.15.1 commonly known as Bluetooth. In such case, this module would be included in the telepresence unit.

The output unit 150 generates outputs relevant to the senses of sight, hearing, touch and the like. Further, the output unit may include a display which is typically implemented to visually display (output) information associated with the telepresence unit and any or all ongoing calls with which it is engaged 250. For example, if the telepresence unit is operating in a phone call mode, the display will generally provide a user interface (“UI”) or graphical user interface (“GUI”) which includes information associated with placing, conducting, and terminating a phone call. As another example, if the telepresence unit is in a video call mode or a photographing mode, the display may additionally or alternatively display images which are associated with these modes, the UI or the GUI. In addition, the display may show information that is derived and transmitted from any or all of the connected home-based sensors. Such information may be shown to the user of the telepresence unit or to the controller during the call. The display module may be implemented using known display technologies including, for example, a liquid crystal display (“LCD”), a thin film transistor-liquid crystal display (“TFT-LCD”), an organic light-emitting diode display (“OLED”), a flexible display and a three-dimensional display. Some of the above displays can be implemented in a transparent or optical transmissive type, which can be named a transparent display. Where the display and a sensor for detecting a touch action (hereinafter called “touch sensor”) configures a mutual layer structure (hereinafter called “touchscreen”), it is able to use the display as an input device as well as an output device. In this case, the touch sensor can be configured as a touch film, a touch sheet, a touchpad or the like. The touch sensor can be configured to convert a pressure applied to a specific portion of the display or a variation of a capacitance generated from a specific portion of the display to an electric input signal. Moreover, it is able to configure the touch sensor to detect a pressure of a touch as well as a touched position or size. If a touch input is made to the touch sensor, a signal corresponding to the touch is transferred to a touch controller. The touch controller processes the signal and then transfers the processed signal to the controller. Therefore, the controller is able to know whether a prescribed portion of the display is touched. A proximity sensor can be provided to an internal area of the telepresence unit enclosed by the touchscreen or around the touchscreen. The proximity sensor is the sensor that detects a presence or non-presence of an object approaching a prescribed detecting surface or an object existing around the proximity sensor using an electromagnetic field strength or infrared ray without mechanical contact. Hence, the proximity sensor has durability longer than that of a contact type sensor and also has utility wider than that of the contact type sensor. The proximity sensor can include one of a transmissive photoelectric sensor, a direct reflective photoelectric sensor, a mirror reflective photoelectric sensor, a radio frequency oscillation proximity sensor, an electrostatic capacitive proximity sensor, a magnetic proximity sensor, an infrared proximity sensor and the like. In case that the touchscreen includes the electrostatic capacitive proximity sensor, it is configured to detect the proximity of a pointer using a variation of electric field according to the proximity of the pointer. In this case, the touchscreen can be classified as the proximity sensor.

In addition, the present invention can include a position-location module 220, which lends itself to potential use both in the operation of the telepresence unit and with the localization of various home-based sensors. The position-location module being functionally adapted to identify or otherwise obtain the location of the telepresence unit. This module may be implemented with a global positioning system (“GPS”) module. In the event that the implemented communication method with the home based sensors is non-wireless or conforms to a short range communication standard, this position-location module could also relay to operator the geographic position of the entire telepresence platform as a whole and thus individual home-based sensors.

The memory unit 160 is generally used to store various types of data to support the processing, control, and storage requirements of the telepresence unit. Examples of such data include program instructions for applications operating on the telepresence unit, contact data, phonebook data, messages, audio, still pictures, moving pictures, etc. Further, a recent use history or a cumulative use frequency of each data (e.g., use frequency for each data set) can be stored in the memory unit 160. Finally, this unit may store data, either complete or compressed, generated and transmitted to the telepresence unit by any or all of connected home sensors. In addition, it can store any set of modified or integrated data as processed by algorithms hosted on either the telepresence unit processor or through non-localized computing. The telepresence unit is able to operate in association with a web storage for performing a storage function of the memory on the internet. The local memory may be implemented using any type or combination of suitable volatile and non-volatile memory or storage devices including hard disk, random access memory (“RAM”), static random access memory (“SRAM”), electrically erasable programmable read-only memory (“EEPROM”), erasable programmable read-only memory (“EPROM”), programmable read-only memory (“PROM”), read-only memory (“ROM”), magnetic memory, flash memory, magnetic or optical disk, multimedia card micro type memory, card-type memory (e.g., SD memory, XD memory, etc.), or other similar memory or data storage device.

The sensing unit 140 provides status measurements of various aspects of the communication terminal. For instance, the sensing unit may detect an open/close status of the communication terminal, relative positioning of components (e.g., a display and keypad) of the communication terminal, a change of position of the communication terminal or a component of the communication terminal, a presence or absence of user contact with the communication terminal, orientation or acceleration/deceleration of the communication terminal. As an example, consider the communication terminal 100 being configured as a slide-type communication terminal. In this configuration, the sensing unit 140 may sense whether a sliding portion of the communication terminal is open or closed. Other examples include the sensing unit 140 sensing the presence or absence of power provided by the power supply 190, the presence or absence of a coupling or other connection between the interface unit 170 and an external device.

The interface unit 230 can be implemented to couple the telepresence unit with external devices in instances when the wireless communication does not handle the above coupling. The interface unit receives data from the external devices or is supplied with the power and then transfers the data or power to the respective elements of the telepresence unit or enables data within the telepresence unit to be transferred to the external devices. The interface unit may be configured using a wired/wireless headset port, an external charger port, a wired data port, a memory card port, a port for coupling to a device having an identity module, audio input/output ports, video input/output ports, an earphone port and/or the like. This interface unit is seperate from the wireless communication unit. The preferred embodiment of this invention does not utilize this unit for the communication with home based sensors, such communication is handled by the wireless communication unit in this scenario.

The controller typically handles the overall operations of the telepresence unit. For example, the controller performs the control and processing associated with voice calls, data communications, video calls, etc. The controller 180 may include a multimedia module 181 that provides multimedia playback. The multimedia module may be configured as part of the controller, or implemented as a separate component. The controller is able to perform a pattern recognizing process for recognizing a writing input and a picture drawing input carried out on the touchscreen as characters or images, respectively. The controller would be responsible for the allocation to memory or discard of any data generated by connected home-based sensors. Such allocation could be done with or without alterations to stored generated datasets. This data processing, while not necessary to the embodiment of this invention, is likely to be used in the majority of applications as it allows for more efficient use of generated data. However, it is conceivable that processing could be done on the server side of operator. In this system, the telepresence unit controller would primarily be responsible for the transmission of this data to another server, which would in turn perform the necessary data processing. This transmission would be executed using the wireless communication unit 110 built into the telepresence unit. It is also possible that no automatic processing would be done to generated datasets. In this case, transmission and/or display on any GUI would be accomplished by the controller.

In the case that the telepresence unit is mobile 230, as defined by the presence of an ability to be moved or driven-possibly through the use of powered wheels, it is possible that some subset of these sensors may go out of range during the normal operation of the telepresence unit and lose wireless connection to a subset of the active home-based sensors. This loss of connection, while more likely to occur under this system arrangement, is not limited to this case. Home-based sensors may lose connectivity for numerous other reasons. This includes, but is not limited to: low power, dynamic physical barrier, wireless signal jamming, unexplained glitch, etc. In this eventuality, the controller shall be responible for taking appropriate action. Said action is dependent upon the use case of the invention and shall be undertaken on a case by case basis. Some examples of potential responses include; but are not limited to: notification of telepresence unit operator, display on GUI of status, notification by wireless means of the user, direct reboot command to anomalous sensor.

It should also be understood that various embodiments described herein may be implemented in a computer-readable medium using, for example, computer software, hardware, or some combination thereof. For a hardware implementation, the embodiments described herein may be implemented within one or more application specific integrated circuits (“ASIC”), digital signal processors (“DSP”), digital signal processing devices (“DSPD”), programmable logic devices (“PLD”), field programmable gate arrays (“FPGA”), processors, controllers, micro-controllers, microprocessors, other electronic units designed to perform the functions described herein, or a selective combination thereof. Such embodiments may also be implemented by the controller.

For a software implementation, the embodiments described herein may be implemented with separate software modules, such as procedures and functions, each of which perform one or more of the functions and operations described herein. Software implementation can be accomplished via software that is installed directly on a terminal or may be provided as a software as a service (“SAAS”) format. The software codes can be implemented with a software application written in any suitable programming language and may be stored in memory such as the memory, and executed by a controller or processor, such as the controller. That is, the software includes source code which is a list of instructions, written in a selected computer language, and then converted into computer machine language, which language the computer uses to build the software “machine” described by the instructions. The software machine is made up of the components referred to above. The source code is a detailed “blueprint” telling the computer how to assemble those components into the software machine. Further, the source code is organized into separate files, files are organized into separate modules, and modules are organized into separate functions or routines to accomplish, via pre-programmed algorithms, the necessary steps in accordance with the method and system of the present invention. It is to be understood that the specific way that the source code is organized into files, modules and functions is a matter of programmer design choice and is not a limitation of the present invention. It should also be understood that the present invention is made possible by virtue of the existence of the internet.

Finally, the power supply should provide direct power flow to all necessary components of telepresence unit. In addition, it can provide power to any subset of the home based sensors that are that are interfaced to the telepresence unit. This power can be provided by an internal battery or external current.

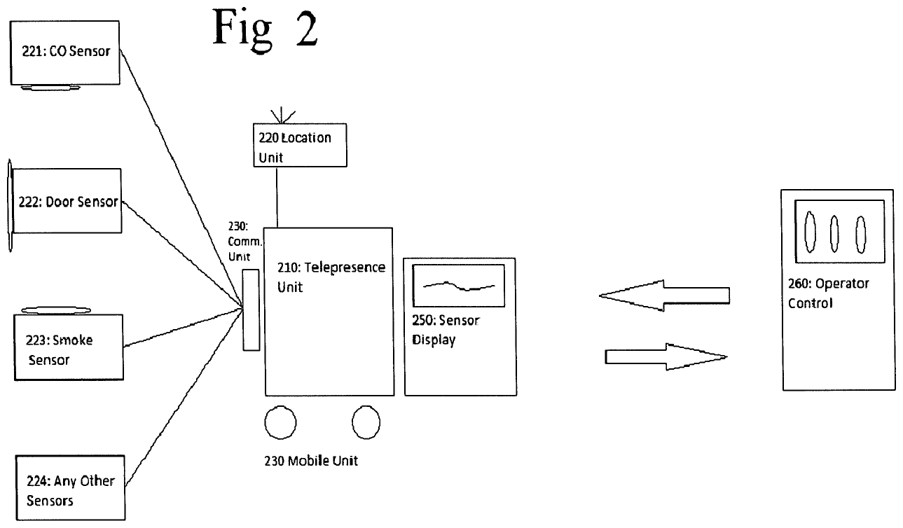

The telepresence unit is to serve as a hub for the home-based safety sensors, such a setup represents one the the key innovations in this invention. Each sensor may operate utilizing any technology to fulfill its function; the aforesaid method does not limit the scope of this invention. For instance, in one embodiment, shown in FIG. 2, there are three specific sensors shown. A Carbon Monoxide Detector 221 for measuring the ambient level of Carbon Monoxide is interfaced to the central telepresence unit. This detector will continuously take readings and report the levels using the wireless communication unit or the interface unit to the telepresence unit. These readings will then be displayed on the telepresence unit, processed by the controller unit, and/or relayed to the operator 260. Not all of these steps must be executed for the present invention to apply. A Door Sensor 222 for measuring door opening events within a building is interfaced to the central telepresence unit. This detector will continuously monitor for the opening of any specified door and alert using the wireless communication unit or the interface unit to the telepresence unit. These readings will then be displayed on the telepresence unit, processed by the controller unit, and/or relayed to the operator 260. A Smoke Sensor 223 smoke levels within a building is interfaced to the central telepresence unit. This detector will continuously monitor for the presence of smoke and alert using the wireless communication unit or the interface unit to the telepresence unit. These readings will then be displayed on the telepresence unit, processed by the controller unit, and/or relayed to the operator 260. Not all of these steps must be executed for the present invention to apply. The aforementioned sensors merely constitute one embodiment of the present invention. Each sensor will operate according to its design specification, either in isolation or in consort. Each sensor is to connect to the telepresence unit, however, the method of connection may vary and need not be uniform. The preferred embodiment of this invention utilizes the wireless connection module in the telepresence unit. 110

Two requirements exist for the relative geographic location of these home-based sensors. First, each sensor is intended to be within a reasonable distance of the telepresence unit as befitting its wireless communication performance. Failure to satisfy this condition would result in failure of the performance of the telepresence unit as the hub for said-home based sensors. In addition, each sensor shall be placed in a location as to maximize its ability to perform its measurement duties. It is possible that a trade off could occur in the event of the telepresence unit's wireless communication unit or the home-based sensor having extremely limited range.

What is claimed is:

1. A system consisting of a telepresence platform for the purpose of facilitating voice and/or video dialogue and home safety information between two parties comprising of:
a. A telepresence unit comprised of a mounted speaker and microphone which enables two-way conversation between an operator located geographically distant from the telepresence unit and second party located geographically near the telepresence unit,
b. A networked base with which various sensors for measurement of home safety and ambient variables, herein referred to as “home-based” sensors can be interfaced, wherein this base can be accessed and manipulated contemporaneously with the telepresence unit,
c. A means of transmission of said data to a remote operator of the telepresence platform.

2. The system in claim 1 wherein the telepresence platform has a display apparatus with which a video of the operator can be displayed during the call.

3. The system of claim 1 wherein the telepresence platform has a camera for the purpose of relaying a video of the user to operator during a call.

4. The system in claim 1 wherein the telepresence platform has wheels or a motor enabling it to be remotely driven about by the operator.

5. The system in claim 1 wherein the base for the operation of sensors is combined with telepresence base into one unit.

6. The system in claim 1 wherein the results of the sensor are displayed and can be transmitted to the operator.

7. The system in claim 1 wherein the home-based sensors are connected to the telepresence unit wirelessly.

8. The system of claim 6 wherein the house-based sensors are connected to the telepresence unit wirelessly using a frequency within the 2.45 Ghz band commonly known as Bluetooth.

9. The system of claim 7 wherein the wirelessly linked sensors array includes any number of humidity sensors for the measurement of ambient humidity within the same premises as the telepresence platform.

10. The system of claim 7 wherein the wirelessly linked sensor array includes any number of temperature sensors for the measurement of ambient temperature within the same premises as the telepresence unit.

11. The system of claim 7 wherein the wirelessly linked sensor array includes any number of flood sensors for the detection of a flood within the same premises as the telepresence unit.

12. The system of claim 7 wherein the wirelessly linked sensor array includes any number of smoke detectors for the detection of smoke within the same premises as the telepresence unit.

13. The system of claim 7 wherein the wirelessly linked sensor array includes any number of smoke detectors for the detection of smoke within the same premises as the telepresence unit.

14. The system of claim 7 wherein the wirelessly linked sensor array includes any number of noxious gas detectors for the detection of gasses with significant morbidity towards human health within the same premises as the telepresence unit.

15. The system of claim 14 wherein the noxious gas detectors constitute carbon monoxide detectors.

16. The system of claim 7 wherein the wirelessly linked sensor array includes any number of door opening detectors.

17. The system of claim 7 wherein the wirelessly linked sensor array includes a fitness tracking bracelet to be worn by user of telepresence system.

18. The system of claim 4, wherein the operator comprises a manual, automated, or manual/automated hybrid control.

19. The system of claim 1 wherein the telepresence platform includes a battery for the powering of aforementioned telepresence in the absence of A/C current.
